(19) United States
(12) Patent Application Publication
(10) Pub. No.: US 2002/0056477 A1
(43) Pub. Date: May 16, 2002

(54) Fluid pressure reduction system comprising disconnectable modules

(75) Inventor: Fabrice Pin, Montgeron (FR)

Correspondence Address: YOUNG & THOMPSON, 745 SOUTH 23RD STREET 2ND FLOOR, ARLINGTON, VA, 22202

(73) Assignee: TAEMA

(21) Appl. No.: 09/987,326

(22) Filed: Nov. 14, 2001

(30) Foreign Application Priority Data
Nov. 14, 2000 (FR) 00 14657

(51) Int. Cl. F16K 27/00

(52) U.S. Cl. 137/454.2

(57) ABSTRACT

A fluid pressure reduction system (1) formed from at least a first module (10) and a second module (20) cooperating with each other in order to ensure at least expansion of the fluid and able to be connected to and/or disconnected from each other, the connection of the modules (10, 20) with each other being provided by connection elements (11, 21, 22) with a rotary ring (21) carried by the first module (10) and/or the second module (20). Such a system may be fitted to any fluid line, especially a medical gas line.

The invention relates to a pressure reduction unit formed from two modules that can be disconnected from each other.

When it is desired to reduce the pressure of a fluid flowing in a fluid line, for example to reduce the pressure of a gas within a gas line, it is common practice to place in the path of the fluid a pressure reduction device or module for controlling the transition of the fluid from the high pressure before expansion to the low pressure after expansion, that is to say the desired expansion pressure.

Document AU-A-446 468 discloses a one-piece pressure-regulating module for a carburettor, comprising a pressure-regulating chamber into which a fluid enters and from which the fluid leaves, the said chamber being furthermore provided with an overpressure outlet passage, that is to say a passage allowing the fluid to be extracted from the chamber should a prefixed pressure threshold be exceeded in the said chamber.

However, the existing one-piece pressure reduction devices have several drawbacks.

Thus, when these known devices must undergo a maintenance, repair or cleaning operation, it is necessary for the line to be momentarily switched to another device, to disconnect, on site and as a matter of urgency, the device to be overhauled before finally reconnecting it so that the line is switched back to the first device. All of these operations are performed along the wall, at the height at which the device is installed and sometimes in small or not very easily accessible locations or enclosures.

Thus, in the best of cases, the intervention takes about ten minutes, for example if it is a question only of replacing standard wear parts.

On the other hand, in the least favourable cases, for example when the device has to be completely changed, the duration of the intervention may be substantially longer, corresponding to the combination of the time needed to carry out particular safety measures, the time to disconnect the device, the time to carry out the actual cleaning or repair and the time to reconnect it after overhaul. In such cases, interruption to the gas service is sometimes inevitable and must therefore be planned well in advance with the hospital service.

In these cases, it may be readily understood that to completely interrupt a flow of fluid in the emergency departments of a hospital system, for example for long periods, from several tens of minutes to several hours, is inconceivable and very undesirable because of the consequences which might result therefrom.

Consequently, the problem that arises is to provide a fluid pressure reduction device intended to be placed in a fluid line and allowing easy maintenance, that is to say maintenance requiring neither a complete stoppage of the flow of fluid in the line or in the line system which lasts as long as with the known devices, nor complex tools or equipment.

Document U.S. Pat. No. 2,628,850 provides a connection/disconnection system for fluid lines, comprising valves which automatically close in the event of disconnection, which does not allow the abovementioned problem to be solved in particular since it does not allow the fluid passing through it to be expanded. This system is in fact merely a simple connector for a fluid line.

The object of the invention is to solve the problems arising with the fluid pressure reduction devices according to the prior art.

The solution provided by the invention is therefore a fluid pressure reduction system formed from at least a first module and a second module cooperating with each other in order to ensure at least expansion of the fluid and able to be connected to and/or disconnected from each other, the connection of the said modules with each other being provided by connection means carried by the said first module and/or the said second module, in which:

the first module ensuring at least expansion of the fluid has a first module body comprising:

at least one internal fluid passage between a fluid inlet orifice and a fluid outlet orifice,

fluid expansion means provided on or in the said internal fluid passage between the said fluid inlet orifices and fluid outlet orifice allowing the fluid to expand from at least a first pressure level to at least a second pressure level; and

the second module has a second module body comprising at least:

a first fluid passage portion provided with a fluid inlet orifice and with a fluid outlet orifice, via which the fluid to be expanded flows,

a second fluid passage portion provided with a fluid inlet orifice and with a fluid outlet orifice, via which the fluid after expansion in the first module flows, and

valve means, making it possible to control the flow of the fluid in the said first fluid passage portion and/or the said second fluid passage portion, the said valve means being placed in the said first fluid passage portion and/or the said second fluid passage portion,

and in which the first and second modules are held connected to or disconnected from each other by connection means comprising a rotary ring having at least one stud cooperating with at least one housing made in at least one of the said first and second modules so that the operator, by rotating the ring, makes the first module move translationally in a direction tending to bring it closer to or further away from the second module, depending on the direction of rotation, in order to allow the said first and second modules to be connected together or disconnected, respectively.

Depending on the case, the system of the invention may comprise one or more of the following features:

the valve means comprise a valve head which normally bears on a valve seat owing to the effect of the pressure exerted by an elastic means so as to at least partly close off the fluid passage portion in which the said valve means are provided and thus prevent any flow of fluid in the said fluid passage portion when the first module and the second module are disconnected from each other;

the valve means are placed in each of the said first and second fluid passage portions;

the first module comprises at least one internal fluid passage comprising, in series, a high-pressure chamber and a low-pressure chamber, the valve head being located between the said high-pressure and low-pressure chambers;

several housings are provided in the outer wall of the first module, preferably from 2 to 4 housings being provided in the wall of the first module;

the housings are inclined ramps;

the internal fluid passage of the first module comprises:

a first protruding end joined to the high-pressure chamber and carrying a fluid inlet orifice for feeding the said high-pressure chamber with unexpanded fluid; and

a second protruding end joined to the low-pressure chamber and carrying a fluid outlet orifice for discharging the expanded fluid from the said low-pressure chamber;

the said first and second protruding ends of the first module cooperate with the valve means of the second module when the first module is connected to the second module;

the second module has a first fluid passage connection element and a second fluid passage connection element which are shaped in order to house the said protruding ends respectively, so as to ensure fluid continuity, on the one hand, between the inlet and the high-pressure chamber and, on the other hand, between the inlet and the low-pressure chamber;

the expansion valve head of the first module is of the type allowing the fluid to escape through the body of the said valve head;

the rotatable ring is carried by the second module;

the second module includes purge means, preferably a purge plug.

The invention also relates to a fluid line equipped with at least one system according to the invention, preferably a network of several lines, and to the use of at least one system according to the invention for expanding a fluid flowing in at least one fluid, particularly gas, line, the fluid line preferably being located, at least in part, inside a building for medical care.

Preferably, the second module carrying the rotary ring is fitted permanently to the said line and the first module can be connected to or disconnected from the said second module by actuating the ring at least rotationally, in order to allow the said first and second modules to be connected to or disconnected from each other, respectively.

The invention will now be described in greater detail with the aid of an exemplary embodiment given as an illustration but implying no limitation.

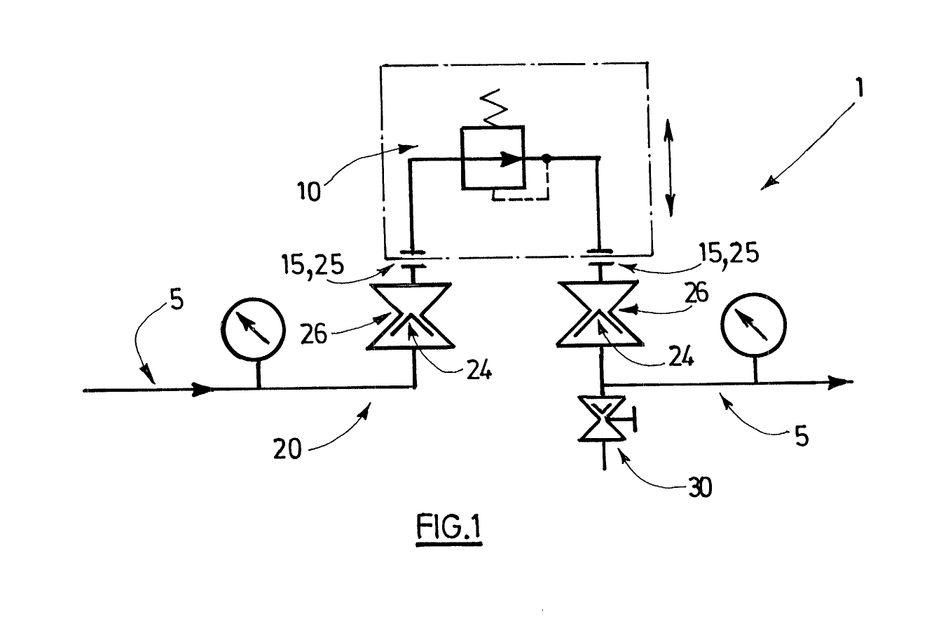

The present invention therefore consists, as shown schematically in FIG. 1, of a fluid pressure reduction device or system 1 formed mainly from at least two modules 10, 20, namely a first module 10 and a second module 20, which cooperate with each other in order to expand the fluid flowing in a fluid line 5, from a high pressure to a desired expansion pressure below the said high pressure. The modules 10, 20 may be easily connected to and disconnected from each other by connection means 15, 25 designed to reduce to a minimum the period of interruption of the flow of fluid.

More specifically, when a maintenance operation has to be carried out on the detachable pressure reduction module 10, also called the first module 10, the operator can quickly and easily disconnect it by actuating the connection means 15, 25, for example simply by disconnecting known connection elements.

The second module 20 or base module remains, during this time, fixed to the fluid line 5, that is to say that it is no longer necessary to disconnect it, as is the case for the devices according to the prior art.

During the period of maintenance of the first module 10, it is possible to temporarily fix a replacement pressure reduction module so as to further minimize the period of interruption of the fluid.

When a break in the gas distribution is not permitted, albeit for a short time, it is always possible, as with the current devices, to use a parallel device which takes over from the device to be repaired. This is accomplished by means of a tap-off/connector on the network upstream of the device and of a tap-off downstream (not shown).

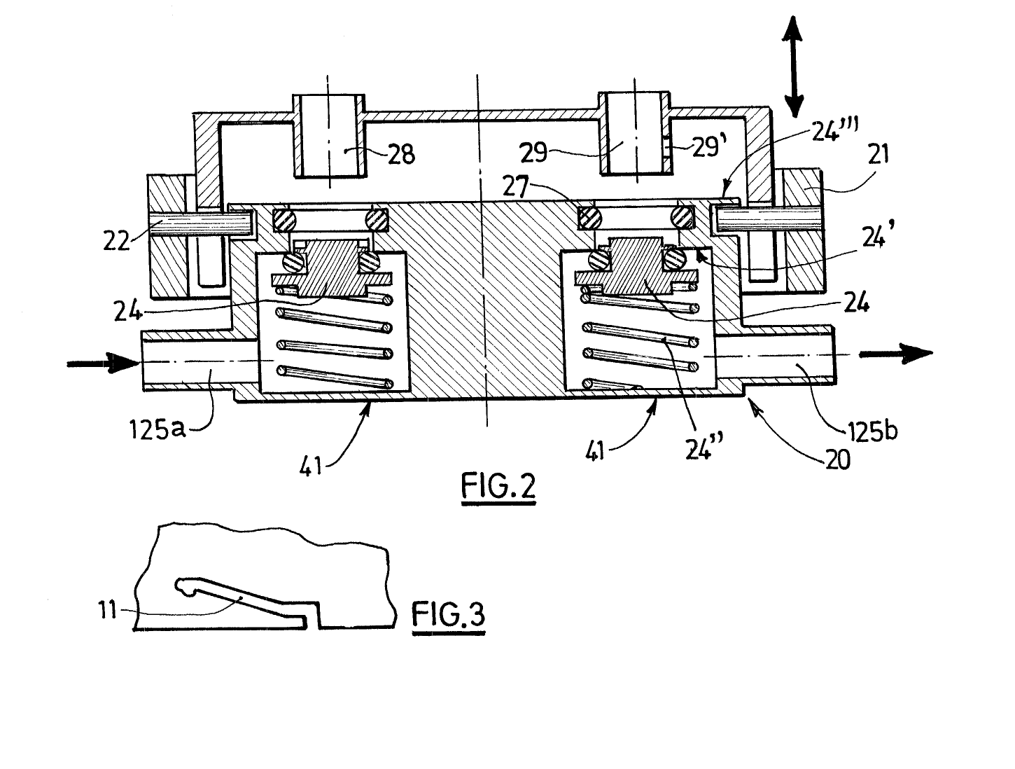

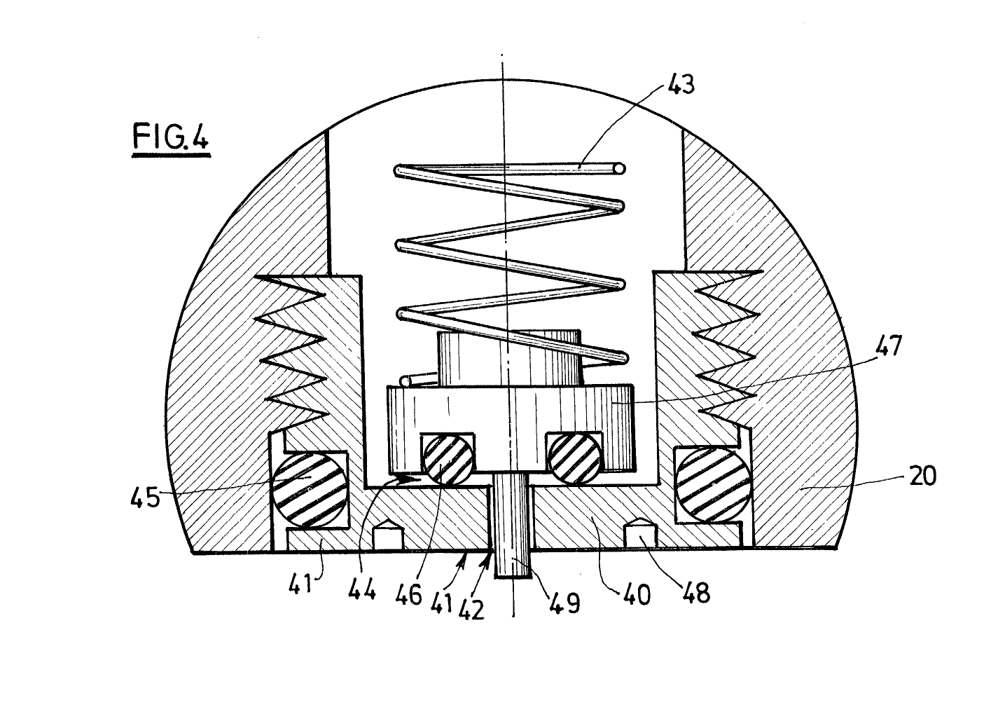

To facilitate the connection/disconnection operation, the modules 10, 20 may be provided with connection means of the type comprising a ring 21 with studs 22 and suitable housings 11, as shown FIGS. 2 and 3.

In this case, rotating the ring 21 with studs 22 moves the module translationally by means of inclined ramps or housings 11 which effect the disconnection in three stages, namely:

shutting-off the two valves 26, simultaneously or not depending on the design envisaged for the device, and therefore gaseous isolation of the module, via suitable valve heads 24;

purging of the module 20, if this is necessary for the application envisaged, in order to prevent a sudden decompression and/or to facilitate the operation of the ring 21. One or more orifices 29′ made in the protrusions 29 and 28 make it possible, when necessary, to purge the gas from 125a to the outside and/or from 125b to the outside and/or from the module 10 to the outside. This purging stops automatically when the module is fully inserted, that is to say when the orifice or orifices 29′ in the protrusions 28 and/or 29 have gone beyond the seal 27 in FIG. 2;

actual decoupling of the two modules 10, 20 from each other.

The profile of the inclined ramps 11 of FIG. 3 is designed to minimize the forces needed and to ensure stable positions and precise disconnection of the modules 10, 20.

The external ring 21 shown in FIG. 2 is free to rotate and may be controlled simply by a drive lever or a suitably shaped external piece allowing easy gripping in order to move the ring.

The said ring 21 is provided with a minimum of 2 or 3 studs 22 which slide in the ramps 11 made opposite them in the outer lower wall of the module 10, when the ring is rotated. This results in a balanced upward or downward displacement of the module 10 depending on the direction of rotation of the ring 21, as indicated by the arrow shown in FIG. 2. The said ring 21 may have a larger number of studs, it being understood that an equivalent number of ramps 11 will be needed on the module 10. The studded ring 21 therefore cooperates with the ramps 11.

Depending on the envisaged application, one or more lines may be disconnected; in this case, the base module 20 has an inlet 125a for the fluid before expansion and an outlet 125b for the fluid after expansion.

Since most of the usual maintenance of the system of the invention is carried out on the detachable module 10, it is possible simply to remove the detachable module 10 in order to carry out the maintenance under easier conditions either directly on the site of use or off-site if the maintenance proves to be more difficult; however, in particular in the second case, it is possible to make a standard replacement of the module 10 during its off-site maintenance.

Moreover, since the functional part of the system 1 is located in the detachable module 10, it is easy, should there be a modification in the functionalities or in the standards, to change the device while keeping the fixed part or module 20 with the user.

The pressure reduction system 1 according to the invention is particularly suitable for use on a hospital site for reducing the pressure of medical gases. However, this pressure reduction system 1 is also suitable for any other hydraulic or pneumatic system placed in series in a fluid line.

The system of the invention is operated by a single control for shutting off, simultaneously or in accordance with the manufacturer's choice, two or more valves 26 of the type having a valve head 24, which isolate that part of the system which lies between the valves from the rest of the line 5.

In this way, the operation is simplified and safety is increased since a single operation is sufficient to operate two valves 26, both having to be closed together, by operating the single ring 21 which has five rotation positions:

stable on position;

temporary purge position;

stable off position;

module maintenance position. This position is accessible only by intentionally removing a safety screw, not shown;

maintenance position for the ring 21. Notches, not shown, in the shoulder 24′″ of FIG. 2 allow the studs 22 to pass and allow the ring 21 to be released if it has to be changed.

In addition, this simplifies the various mechanisms and the very principle of closure by means of valve heads 24 automatically takes up any slack and therefore eliminates adjustments and wear.

To improve the operating safety further, a purge system is preferably provided, as shown in detail in FIG. 4, on the base module 20, for example one or more purge plugs 40 formed from a plug body 41 which is screwed, so as to be gastight (via the O-ring seal 45), into the body of the base module 20, each plug being provided with a purge valve head 47 normally pushed down by a spring 43 onto the purge valve seat 44 provided in the body 41 of the plug 40. The pin 49 is normally used both to centre and operate the purge valve head 47, but it is also designed to partially obstruct the purge orifice 42 drilled through the plug body 41 and thus limit any leakage should the seal 45 or the seat 44 fail. The spring 43 may also, but not necessarily, be the spring used for closing one of the valve heads 24 for sealing with respect to the previous module. The plug 40 is fitted into its housing in the body of the base module 20 thanks to drillholes 48 suitable for taking a tightening tool, for example, but not necessarily, a standard tightening tool for hospital fittings.

The fact of placing the purge on such a plug 40 makes both manufacture and maintenance easy, and also offers the possibility of changing the purge, or even dispensing with the purge simply by replacing the purge plug 40 with an undrilled plug.

The module 10 may be any device installed in series in a hydraulic or pneumatic line that it might be necessary to cut off, isolate or interchange, such as for example one or more sensors, indicators, sampling bottles, fluid injection points or, as in the example discussed below, a gas pressure reducer.

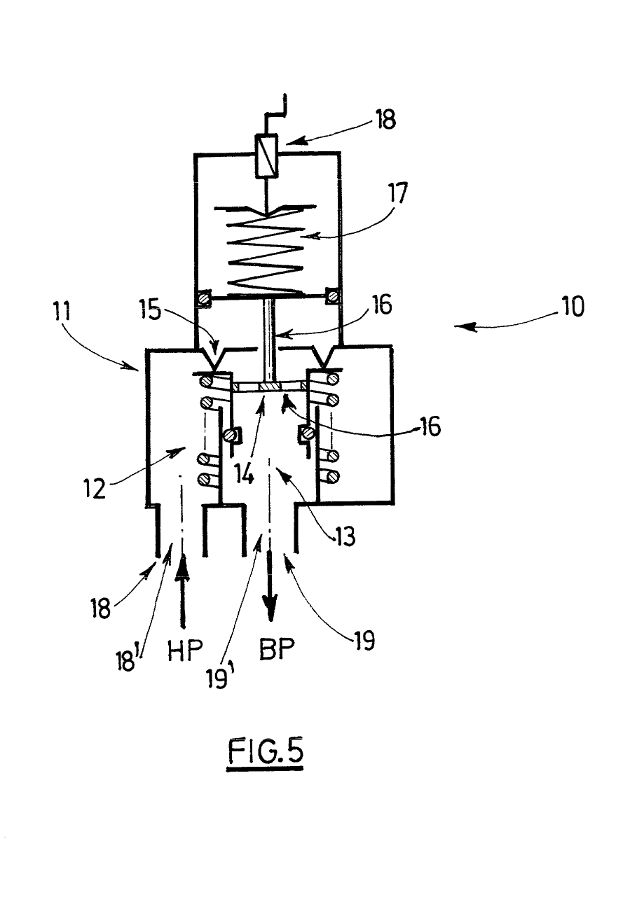

FIG. 5 shows one possible arrangement of a pressure reduction module 10 fitted to a system according to the invention, which comprises a module body 11 having at least one chamber or passage 12 for as yet unexpanded high-pressure fluid and at least one chamber or passage 13 for low-pressure fluid, that is to say expanded fluid.

In this case, the expansion of the gas takes place conventionally, that is to say between an expansion valve head 14 and its seat 15, but the exhaust takes place here actually through 16 of the valve head 14. In other words, entry and exit of the gas therefore take place on the same side of the valve head 14.

This novel geometry allows, in a small space, the valve head 14 and the seat 15 to have a large circumference, and therefore, for the same flow rate, a small displacement of the valve head and therefore better performance, at the same time as a large flow area 16.

This geometry also makes it possible to obtain, without an additional piece, a valve head of the “compensated valve” type, that is to say one in which the forces resulting from the high pressure cancel out and therefore the pressure variation upstream has no or very little effect on the adjustment and the operation of the pressure reducer.

In FIG. 5, the gas under high pressure therefore enters via the chamber 12, undergoes expansion between the valve head 14 and the seat 15 and is then discharged, after expansion, via the chamber 13.

The chamber 12 of the pressure reduction module 10 is supplied with the incoming fluid via the fluid inlet 125a of the base module 20, while the chamber 13 of the module 10 feeds the fluid outlet 125b of the base module 20 with expanded fluid.

The pressure reduction level is adjusted using adjustment means 18, for example those manually actuated by the operator, which act, directly or indirectly, on the expansion valve head 14, preferably by means of an expansion spring 17.

The protruding ends 18 and 19, connected to the high-pressure chamber 12 and low-pressure chamber 13 of the pressure reduction module 10 respectively, allow the said chambers 12, 13 to be joined to the fluid inlet and outlet 125a, 125b of the base module 20.

More specifically, it is the protruding ends 18 and 19 which allow the valve heads 24 of the base module 20 to be activated by exerting mechanical pressure on them in the direction tending to lift them off their seats 24′ when the pressure reduction module 10 is connected to the base module 20, that is to say a force opposing that exerted by the valve head springs 24″.

The fluid passage connection elements 28, 29 carried by the base module 20 are shaped to house the said protruding ends 18 and 19 respectively, so as to ensure fluid continuity, on the one hand, between the inlet 125a and the high-pressure chamber 12 and, on the other hand, between the inlet 125b and the low-pressure chamber 13. Sealing is then provided by suitable O-ring seals.

Although this embodiment is preferred, it would also be possible to produce a system according to the invention the other way round, that is to say the ring 21 with studs 22 could be carried by the detachable first module 10, while the inclined ramps 11 could be provided in the fixed second module 20.

1. Fluid pressure pressure reduction system (1) formed from at least a first module (10) and a second module (20) cooperating with each other in order to ensure at least expansion of the fluid and able to be connected to and/or disconnected from each other, the connection of the said modules (10, 20) with each other being provided by connection means (11, 21, 22) carried by the said first module (10) and/or the said second module (20), in which:
the first module (10) ensuring at least expansion of the fluid has first module a body (11) comprising:
at least one internal fluid passage (12, 13, 16, 16′, 18, 19) between a fluid inlet orifice and a fluid outlet orifice,
fluid expansion means (14, 15) provided on or in the said internal fluid passage (12, 13, 16, 16′, 18, 19) between the said fluid inlet orifices and fluid outlet orifice allowing the fluid to expand from at least a first pressure level to at least a second pressure level; and
the second module (20) has a second module body comprising at least:
a first fluid passage portion (125a) provided with a fluid inlet orifice and with a fluid outlet orifice, via which the fluid to be expanded flows,
a second fluid passage portion (125b) provided with a fluid inlet orifice and with a fluid outlet orifice, via which the fluid after expansion in the first module flows, and
valve means (24, 24′, 24″), making it possible to control the flow of the fluid in the said first fluid passage portion (125a) and/or the said second fluid passage portion (125b), the said valve means being placed in the said first fluid passage portion (125a) and/or the said second fluid passage portion (125b),
and in which the first and second modules (10, 20) are held connected to or disconnected from each other by connection means comprising a rotary ring (21) having at least one stud (22) cooperating with at least one housing (11) made in at least one of the said first and second modules (10, 20) so that the operator, by rotating the ring (21), makes the first module (10) move translationally in a direction tending to bring it closer to or further away from the second module (20), depending on the direction of rotation, in order to allow the said first and second modules to be connected together or disconnected, respectively.

2. System according to claim 1, characterized in that several housings (11) are provided in the outer wall of the first module (10), preferably from 2 to 4 housings being provided in the wall of the first module (10).

3. System according to either of claims 1 and 2, characterized in that the said housings (11) are inclined ramps.

4. System according to one of claims 1 to 3, characterized in that the valve means (24, 24′, 24″) are placed in each of the said first (125a) and second (125b) fluid passage portions, preferably the valve means (24, 24′, 24″) comprising a valve head (24) which normally bears on a valve seat (24′) owing to the effect of the pressure exerted by an elastic means (24″) so as to at least partly close off the fluid passage portion in which the said valve means (24, 24′, 24″) are provided and thus prevent any flow of fluid in the said fluid passage portion (125a, 125b) when the first module (10) and the second module (20) are disconnected from each other.

5. System according to one of claims 1 to 4, characterized in that the first module (10) comprises at least one internal fluid passage (12, 13, 16, 16′ 18, 19) comprising, in series, a high-pressure chamber (12) and a low-pressure chamber (13), the valve head (24) being located between the said high-pressure and low-pressure chambers (12, 13).

6. System according to one of claims 1 to 5, characterized in that the internal fluid passage (12, 13, 18, 19) of the first module (10) comprises:
a first protruding end (18) joined to the high-pressure chamber (12) and carrying a fluid inlet orifice (18′) for feeding the said high-pressure chamber (12) with unexpanded fluid; and
a second protruding end (19) joined to the low-pressure chamber (13) and carrying a fluid outlet orifice (19′) for discharging the expanded fluid from the said low-pressure chamber (13);
and in that the said first and second protruding ends (18, 19) of the first module (10) cooperate with the valve means (24, 24′, 24″) of the second module (20) when the first module (10) is connected to the second module (20).

7. System according to one of claims 1 to 6, characterized in that at least one stud (22) of the rotary ring (21) cooperates with a housing (11) so as to slide along the latter when the ring is being rotated.

8. System according to one of claims 1 to 7, characterized in that the second module (20) has a first fluid passage connection element (28) and a second fluid passage connection element (29) which are shaped in order to house the said protruding ends (18, 19) respectively, so as to ensure fluid continuity, on the one hand, between the inlet (125a) and the high-pressure chamber (12) and, on the other hand, between the inlet (125b) and the low-pressure chamber (13).

9. System according to one of claims 1 to 8, characterized in that the expansion valve head (14) of the first module (10) is of the type allowing the fluid to escape through (16) the body of the said valve head (14).

10. System according to one of claims 1 to 9, characterized in that the second module (20) has purge means (40 to 49), preferably a purge plug (40).

11. System according to one of claims 1 to 10, characterized in that the rotatable ring (21) is carried by the second module (20).

12. Fluid line equipped with at least one system according to one of claims 1 to 11, preferably a network of several lines.

13. Use of at least one system according to one of claims 1 to 11, for expanding a fluid flowing in at least one fluid, particularly gas, line (5), the fluid line (5) preferably being located, at least in part, inside a building for medical care.

14. Use of at least one system according to one of claims 1 to 11 for expanding a fluid flowing in at least one fluid, particularly gas, line (5), in which the second module (20) carrying the rotary ring (21) is fitted permanently to the said line (5) and in which the first module (10) can be connected to or disconnected from the said second module (20) by actuating the ring (21) at least rotationally, in order to allow the said first and second modules to be connected to or disconnected from each other, respectively.
